(19) United States
(12) Patent Application Publication
(10) Pub. No.: US 2020/0393586 A1
(43) Pub. Date: Dec. 17, 2020

(54) Lowstand erosional seismic stratigraphy

(71) Applicant: John A. Babcock, Houston, TX (US)

(72) Inventor: John A. Babcock, Houston, TX (US)

(21) Appl. No.: 16/501,828

(22) Filed: Jun. 12, 2019

(51) Int. Cl. G01V 1/30

(52) U.S. Cl. CPC G01V 1/30

(57) ABSTRACT

A seismic interpretation method for identifying subsurface hydrocarbon bearing traps of Eocene/Paleocene age in valley fill depositional systems comprising as computer implemented modeling software and processed seismic data. The valley dispositional system is further defined by identifying field stratigraphy and erosional trapping mechanisms and confirming structural closure. The method further includes identifying structural aspects caused by sagging, rollover, and determining the presence of high amplitude events in the erosional trap.

### CROSS REFERENCE TO RELATED APPLICATIONS

This application claims benefit of U.S. Provisional Patent Application No. 62/680,298 filed Jun. 4, 2018, the contents of which herein incorporated by reference in their entirety.

### BACKGROUND

### Field

Embodiments of This disclosure relates to techniques for the exploration of oil and gas. More specifically, it relates to lowstand erosional seismic stratigraphy.

### DESCRIPTION OF THE RELATED ART

The lowering of sea level is the primary mechanism associated with the development of incised valleys. In turn, incised valleys are the evidence for the existence of lowstand and transgressive deposition.

The erosion that creates many incised valleys is thought to be linked to relative sea-level fall, although climatically produced changes in discharge and/or sediment supply may independently cause incision, even in areas far removed from the coast. In the case of valleys in coastal areas, fluvial deposition typically begins at the mouth of the incised-valley system when sea level is at its lowest point and expands progressively farther up the valley as the transgression proceeds, producing depositional onlap in the valley. Valley-fill sequences are known to provide seals and reservoirs for stratigraphically trapped petroleum accumulations.

Late Paleocene and early Eocene was a time of Thermal Maximum when the average global temperature was 8° C. warmer than today. The exact age and duration of the event is uncertain but it is estimated to have occurred around 55.5 million years ago (between the Paleocene and Eocene geological epochs).

The Thermal Maximum was a period of maximum sea level fluctuations. During sea level lows, incised valleys were created and filled with mud during subsequent transgressions that separate intervals. These include several Lower Wilcox intervals (Late Paleocene), which are major hydrocarbon bearing formations along the U.S. Gulf Coast.

Galloway et al (2011) taught that sequence stratigraphy is a methodology that provides a framework for the elements of any depositional setting, facilitating paleogeographic reconstructions and the prediction of facies and lithologies away from control points. This framework ties changes in stratal stacking patterns to the responses to varying accommodation and sediment supply through time. Stratal stacking patterns enable determination of the order in which strata were laid down and explain the geometric relationships and the architecture of sedimentary strata. The sequence stratigraphic framework also provides the context within which to interpret the evolution of depositional systems through space and time. The main tool used in sequence stratigraphic analysis is the stacking pattern of strata and the key stratigraphic boundary surfaces are defined by different stratal stacking patterns. The definition of these units is independent of temporal and spatial scales, and of the mechanism of formation.

The sequence stratigraphic approach relies on the observation of stratal stacking patterns and the key stratigraphic boundary surfaces are defined by different stacking patterns. Construction of this framework ensures the success of the method in terms of its objectives to provide a process-based understanding of the stratigraphic architecture.

The surfaces that are selected as sequence boundaries vary from one sequence stratigraphic approach to another. In practice, the selection is typically a function of which surfaces are best expressed within the context of each situation, depending upon tectonic setting, depositional setting, types of available data and the scale of observation. The high degree of variability in the expression of stratigraphic boundary surfaces requires the adoption of a methodology that is sufficiently flexible to accommodate the wide range of possible scenarios.

Devine and Wheeler (1989) taught that exploration potential exists where updip convex curvature of mudstone filled valleys or the intersection of primary and secondary drainages form lateral barriers to petroleum migration. These barriers can form stratigraphic traps or enhance structural closure. Eocene-Paleocene Epoch (EPE) strata constitute a regressive clastic wedge of fluvial and deltaic deposits formed during a gradual sea-level rise on passive margins. Multiple episodes of sea-level lowstand occurred during the rise; each produced deep incisement of river valleys across the Tertiary coastal plain and shelf areas. The relative age of individual valleys can be determined based on the ordered occurrence of valley-fill tops within a series of time-stratigraphic markers correlated in the intervening and surrounding EPE.

Most EPE strata include valley-fills that represent drowning of riverine embayment's in shoreline settings during transgression. These valley-fill sequences consist dominantly of mudstones with minor sandstones, providing limited reservoir potential. Exploration potential can exist where thick mudstone deposits can serve as lateral and vertical seals for petroleum migration. Potential reservoirs exist in EPE fluvial and deltaic strata that have been truncated below the unconformity at the base of the valley sequence.

Stacking of multiple-aged valleys is common in EPE and has produced thick sequences of relatively impermeable valley-fill mudstone. Stratigraphic traps can be anticipated along major updip convex curvatures of the valley trends or at the intersections of primary and secondary drainages. These situations can also enhance structural closures. Accurate mapping of the valley margin trends by the time-stratigraphic methods is crucial for detailed delineation of trapping geometries.

### SUMMARY

One embodiment of this disclosure comprises a stratigraphic trapping system created by meander bends and structural noses forming traps against a shale filled erosional sequence.

One embodiment of this disclosure comprises a stratigraphic trapping system created by erosional channels/canyons in the lower (older) erosional sequence, which occurred during a regressive cycle. These channel/canyons became shale filled during the next transgressive cycle creating traps.

One embodiment of this disclosure comprises a stratigraphic trapping system created by erosional channels/canyons in the middle (younger) erosional sequence, which occurred during a regressive cycle. These eroded into the previous transgressive cycle of fluvial—deltaic deposition, forming erosional remnants. These channel/canyons became shale filled during the next transgressive cycle creating traps.

One embodiment of this disclosure comprises a stratigraphic trapping system created by submarine canyon and erosional gully lowstand sand deposits being preserved as erosional remnants between the lower erosional sequence and the middle erosional sequence. These sand deposits are completely encased in shale between the lower and middle erosional sequences.

One embodiment of this disclosure comprises picking the base of the lower erosional sequence (BLES) boundary using a 3-D seismic section rotated parallel to the incised valley.

One embodiment of this disclosure comprises picking the top of the lower erosional sequence (TLES) boundary using a 3-D seismic section rotated perpendicular to paleo-coast line.

One embodiment of this disclosure comprises picking the base of the middle erosional sequence (BMES) boundary using a 3-D seismic section rotated perpendicular to paleo-coast line.

One embodiment of this disclosure comprises determining if noticeable sag occurs in the underlying BLES indicative of an overlying productive interval.

One embodiment of this disclosure comprises determining arching effect at the BMES due to differential compaction indicative of an underlying productive interval.

One embodiment of this disclosure comprises determining the presence of a high amplitude event associated with hydrocarbon productive intervals.

One embodiment of this disclosure comprises optimizing the color bar to enhance interpreter's ability to pick key boundaries.

### BRIEF DESCRIPTION OF THE DRAWING

So that the manner in which the above recited features can be understood in detail, a more particular description of the embodiments briefly summarized above may be had by reference to the embodiment below, some of which are illustrated in the appended drawing. It is to be noted, however, that the appended drawing illustrates only typical embodiments and are therefore not to be considered limiting of its scope, for the embodiments may admit to other equally effective embodiments.

FIG. 1 shows a eustatic curve during the Eocene Paleocene Epochs

FIG. 2 shows a block diagram of an EPE depositional model

FIG. 3 shows a section view schematic of an erosional truncation trap.

FIG. 4 shows a map view schematic of an erosional truncation trap

FIG. 5 shows a section view schematic of a basal erosional remnant trap

FIG. 6 shows a map view schematic of a basal erosional remnant trap

FIG. 7 shows a section view schematic of an intermediary erosional remnant trap

FIG. 8 shows a map view schematic of an intermediary erosional remnant trap

FIG. 9 shows a section view schematic of an inter-channel erosional remnant trap

FIG. 10 shows a map view schematic of an inter-channel erosional remnant trap

FIG. 11 shows interpreted 3-D seismic section for analog field with a basal erosional remnant trap

FIG. 12 shows interpreted 3-D seismic section for analog field inter-channel erosional remnant trap

### DETAILED DESCRIPTION

Lowstand Erosional Seismic Stratigraphy (LESS) interpretation method is used to identify hydrocarbon bearing traps within incised valley systems specifically in the late Paleocene Era. The incised valleys form because the transport capacity of a river exceeds its sediment supply. An incised-valley system is defined as a fluvially eroded, elongate topographic low that is characteristically larger than a single channel and is marked by an abrupt seaward shift of depositional facies across a regionally mappable sequence boundary at its base.

With sea level rise due to global warming, rivers erode the land mass and deposit fluvial/deltaic sands in shallow water.

With a decline in sea level, the rivers make their way towards the new shoreline. The previously deposited fluvial/deltaic sands are now exposed and subject to erosion. These sands are transported and deposited as lowstand deposits along the newly established shoreline.

With another rise of sea level. The sea transgresses over the land mass. The entrenched shoreline valleys and submarine canyons which formed during the previous sea level drop are back-filled with primarily estuarine muds that later compact into shale. As the sea level continued to rise, fluvial/deltaic sands were once again deposited into the shallow water near shore over the top of the previously eroded now shale-filled section.

With another decline in sea level, the rivers make their way towards the new shoreline. The previously deposited fluvial/deltaic sands are now exposed and subject to erosion. Once again, these sands are transported and deposited offshore along the newly established shoreline.

As sea level rises again, the incised valleys once more are back-filled with the near shore muds until the water depth is deep enough for the deposition of clean deltaic sands by the river systems.

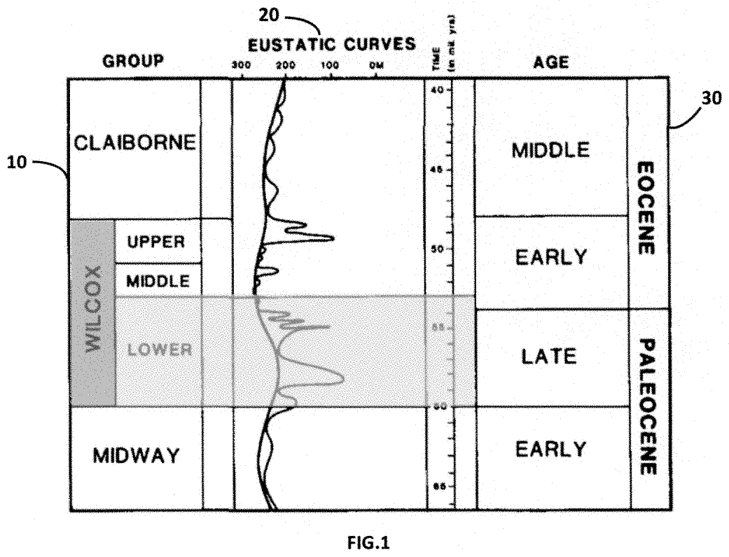

FIG. 1 is a diagram showing eustatic curves for the late Paleocene and Eocene Epochs. Column 10 entitled Group refers to the local or regional names given to groups of subsurface formations. Column 20 entitled Eustatic Curves shows the global change in sea level shown in meters and the duration of the change shown in millions of years. Column 30 is the relative geologic age corresponding to the eustatic curves.

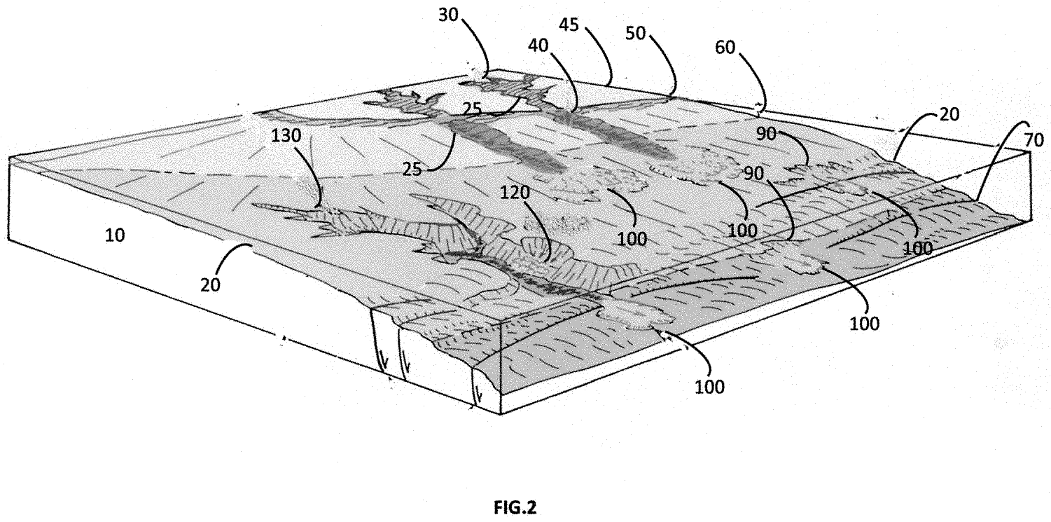

FIG. 2 is geological model built on a platform 10 with platform margins 20 that display key depositional features. Incised valleys 25 are comprised of bay 30 in high stand 45 and drowned valley 40 emanating from shore line 50 into the first lowstand 60. Potential hydrocarbon bearing traps are deposited in lowstand wedges 100 at the outflow of incised valleys 25, submarine canyon 130 and gullies 90 and into the second lowstand 70. In addition, slumps 120 may also occur in the submarine canyon.

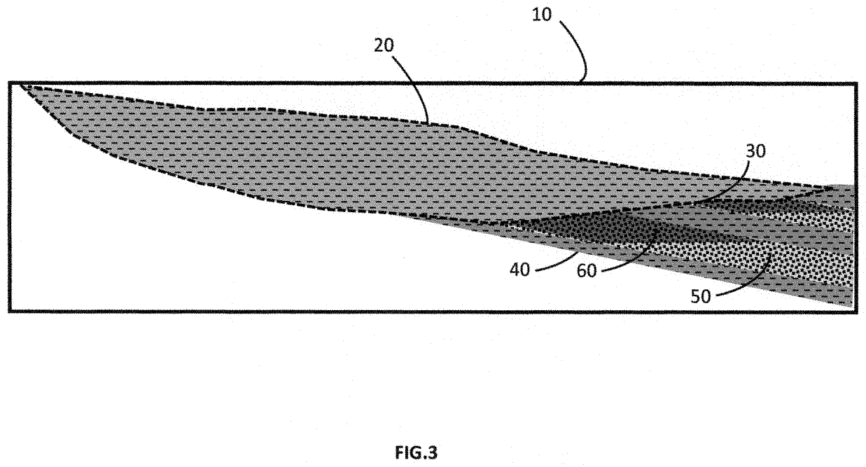

FIG. 3 is a section view of an erosional truncation trap model 10 shale filled with middle erosional sequence 20 that terminates against unconformity 30. The erosional truncation trap was created by meander bends and structural noses of beds of sand 50 and shale 40 forming as traps against the shale filled erosional sequence 20. Hydrocarbon 60 can be potentially trapped in sand 50.

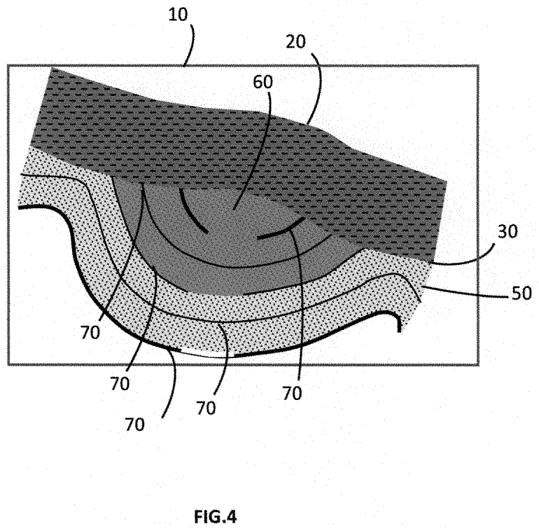

FIG. 4 is a map view of and erosional truncation trap model 10 shale filled with middle erosional sequence 20 that terminates against unconformity 30. The erosional truncation trap was created by meander bends and structural noses depicted by contours 70 of beds of sand 50 forming as traps against the shale filled erosional sequence 20. Hydrocarbon 60 can be potentially trapped in sand 50.

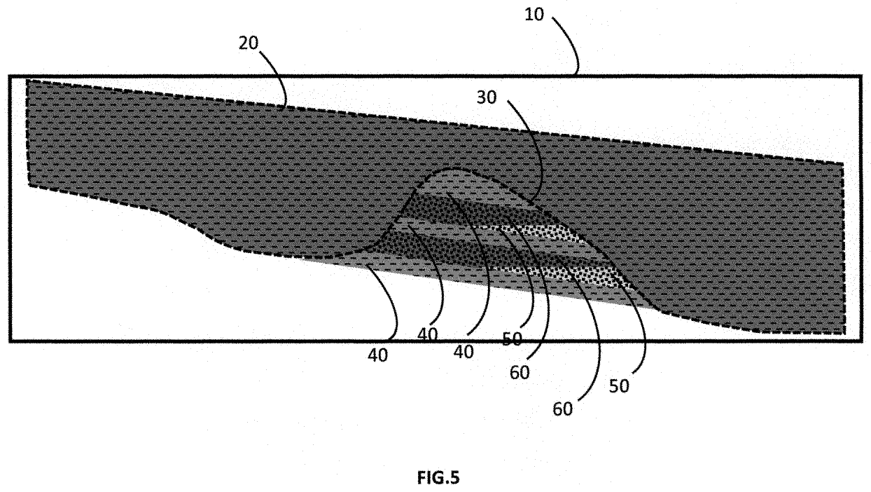

FIG. 5 is a section view of a basal erosional remnant trap model 10 shale filled with Lower Erosional Shale Filled sequence 20 that terminates against unconformity 30. The basal erosional remnant trap was created by channels/canyons in the lower (older) erosional sequence, which occurred during an earlier regressive cycle. These channels/canyons eroded into the previous transgressive cycle of fluvial—deltaic deposition depositing shales 40 and sands 50 and later forming erosional remnants that became shale filled during the next transgressive cycle. Hydrocarbons 60 were introduced into the basal erosional remnant trap 10.

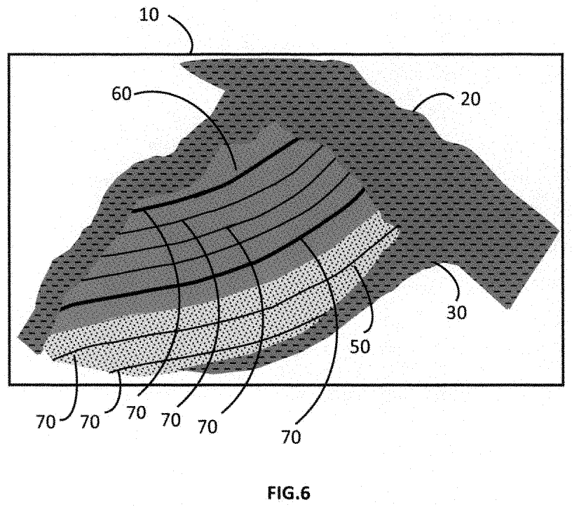

FIG. 6 is a map view of a basal erosional remnant trap model 10 shale filled with Lower Erosional Shale Filled sequence 20 that terminates against unconformity 30. The basal erosional remnant trap was created by channels/canyons in the lower (older) erosional sequence, which occurred during an earlier regressive cycle. These channels/canyons eroded into the previous transgressive cycle of fluvial—deltaic deposition depositing sands 50 and later forming erosional remnants that became shale filled during the next transgressive cycle. Hydrocarbons 60 were introduced into the basal erosional remnant trap 10. Structural contours are shown by 70.

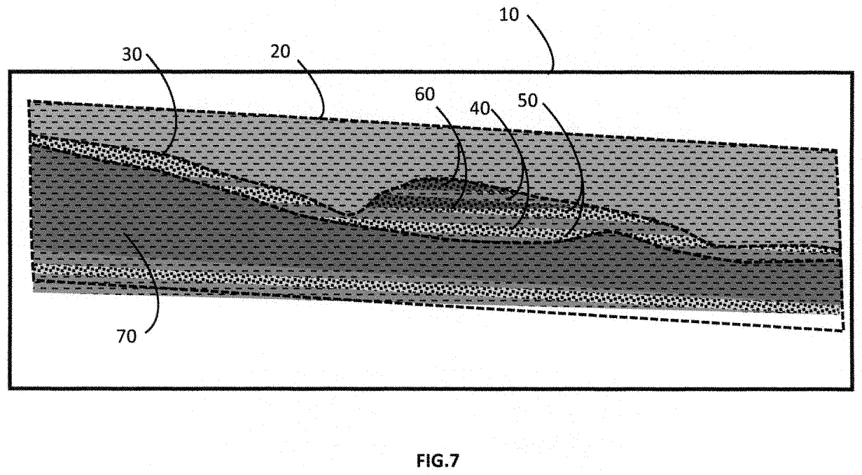

FIG. 7 is a section view of an intermediary erosional remnant trap model 10 shale filled with middle erosional shale-filled sequence 20 that terminates against unconformity 30. This trap was created by erosional channels/canyons in the middle (younger) erosional sequence, which occurred during a previous regressive cycle and sit above the Lower Erosional Shale Filled Sequence 70. These channels/canyons eroded into the previous transgressive cycle of fluvial—deltaic deposition depositing shales 40 and sands 50 and later forming erosional remnants that became shale filled during the next transgressive cycle. Hydrocarbons 60 were introduced into the intermediary erosional remnant trap 10.

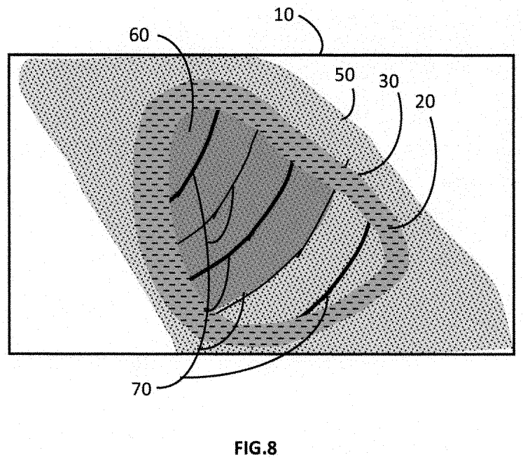

FIG. 8 is a map view of an intermediary erosional remnant trap model 10 shale filled with middle erosional shale-filled sequence 20 that terminates against unconformity 30. This trap was created by erosional channels/canyons in the middle (younger) erosional sequence, which occurred during a previous regressive cycle and sit above the lower erosional shale filled sequence 20. These channels/canyons eroded into the previous transgressive cycle of fluvial—deltaic deposition depositing sands 50 and later forming erosional remnants that became shale filled during the next transgressive cycle. Hydrocarbons 60 were introduced into intermediary erosional remnant trap 10. Structural contours are shown by 70.

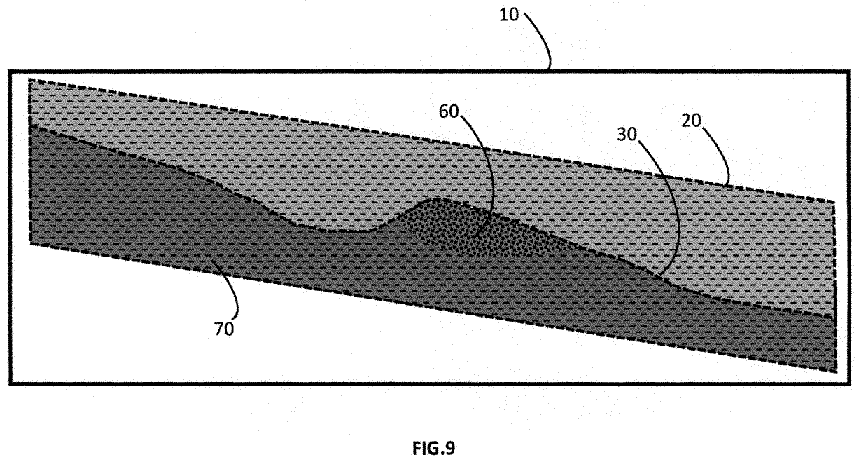

FIG. 9 is a section view of an inter-channel erosional remnant trap model 10 shale filled with middle erosional shale filled sequence 20 that terminates against unconformity 30. inter-channel erosional remnant trap was created by submarine canyon and erosional gully lowstand sand deposits 60 being preserved as erosional remnants between the lower erosional sequence and the middle erosional sequence. These sand deposits 60 are completely encased in shale between the lower 70 and middle 20 erosional sequences. The sands 60 are of high reservoir quality and are usually gas/condensate productive.

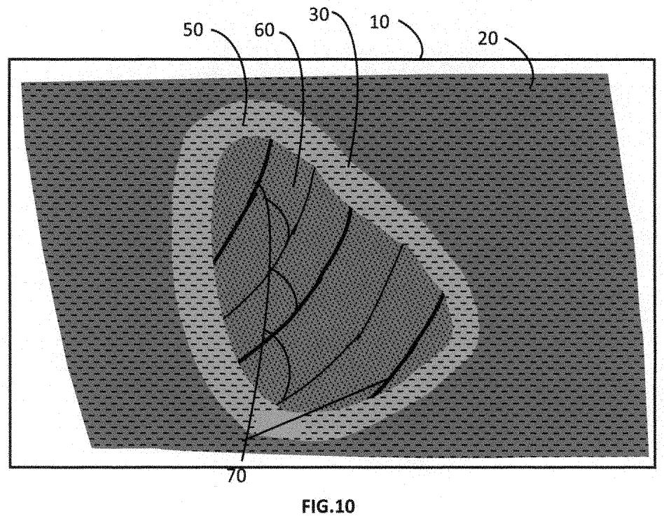

FIG. 10 is a map view of an inter-channel erosional remnant trap model 10 shale filled with middle and lower erosional shale filled sequence 20 that terminates against unconformity 30. Inter-channel erosional remnant trap was created by submarine canyon and erosional gully lowstand sand deposits 60 being preserved as erosional remnants between the lower erosional sequence and the lower middle erosional sequence. These sand deposits 60 are completely encased in shale between the lower 70 and lower middle 20 erosional sequences. The sands 60 are of high reservoir quality and are usually gas/condensate productive.

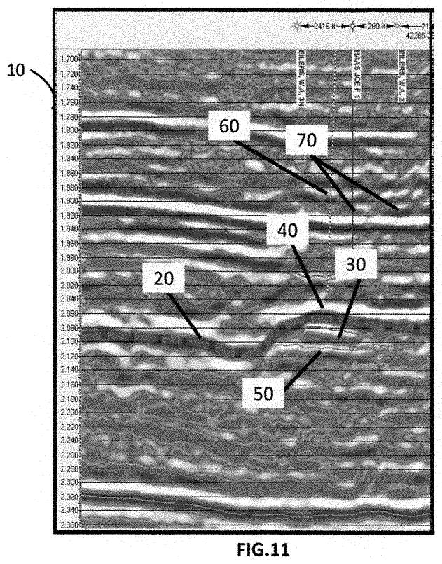

FIG. 11 is an optimized color bar 3-D seismic section 10 displaying an actual analog oilfield 20 with inter-channel erosional remnant trap. Analog field 20 is bounded by base lower erosional sequence 30. Key hydrocarbon indicators include arching effect 70 at the base middle erosional sequence 50 due to differential compaction and brightening of high amplitude event 50 in analog field 20. Also shown are in-plane projected wellbore 60 and out-of-section projected wellbores 70.

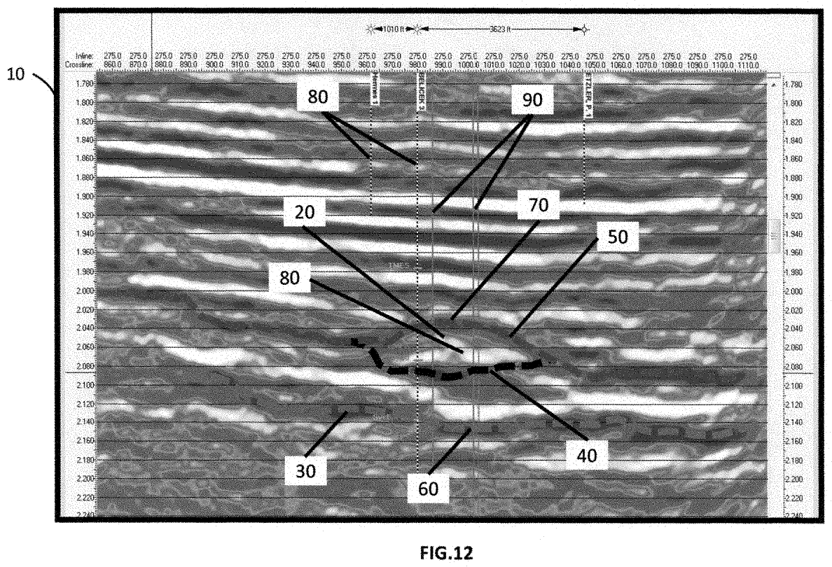

FIG. 12 is an optimized color bar 3-D seismic section 10 displaying an actual analog oilfield 20 with an inter-channel erosional remnant trap. Analog field 20 is bounded by base lower erosional sequence 30, top lower erosional sequence 40 and base middle

1. A seismic interpretation method for identifying subsurface hydrocarbon bearing traps of Eocene/Paleocene age in valley fill depositional systems comprising: a computer implemented modeling software with processed or reprocessed seismic data, the representation being displayed on a graphic user interface; identifying and correlating stratigraphic boundary surfaces using analogous field data; adjusting computer implemented modeling software color bar to optimize interpretability of previously recorded seismic traces thus enabling interpretation beyond the analogous field data; identifying field stratigraphy, erosional trapping mechanism and confirming structural closure; identifying structural aspect caused by differential compaction; identifying structural aspect caused by sagging and rollover; determining the presence of high amplitude events in the erosional trap.

2. The seismic interpretation method of claim 1, wherein the valley fill depositional system is referred to as lowstand erosional seismic stratigraphy (LESS).

3. The computer implemented method of claim 1, wherein the representation is displayed upon the graphic user interface using a 2D, 3D, or 4D arrangement.

4. The erosional trapping mechanism of claim 1, wherein the trap is an erosional truncation trap.

5. The erosional trapping mechanism of claim 1, wherein the trap is a basal erosional remnant trap.

6. The erosional trapping mechanism of claim 1, wherein the trap is an intermediary erosional remnant trap.

7. The erosional trapping mechanism of claim 1, wherein the trap is an inter-channel erosional remnant trap.

8. The erosional trapping mechanism of claim 1, wherein the stratigraphic trapping system is created by meander bends and structural noses forming traps against shale filled erosional sequences.

9. The erosional trapping mechanism of claim 1, wherein the stratigraphic trapping system is created by erosional channels/canyons in the lower (older) erosional sequence, which occurred during a regressive cycle and later became shale filled during the next transgressive cycle thus creating traps.

10. The erosional trapping mechanism of claim 1, wherein the stratigraphic trapping system is created by erosional channels/canyons in the middle (younger) erosional sequence which occurred during a regressive cycle.

11. The erosional sequence of claim 10, wherein the previous transgressive cycle of fluvial-deltaic deposition formed erosional remnants which became shale filled during the next regressive cycle thus creating traps.

12. The erosional trapping mechanism of claim 1, wherein the stratigraphic trapping system is created by submarine canyon and erosional gully lowstand sand deposits being preserved as erosional remnants between the lower erosional sequence and the middle erosional sequence.

13. The erosional trapping mechanism of claim 12, wherein the sand deposits are completely encased in shale between the lower and middle erosional sequences.

14. The stratigraphic boundary surfaces of claim 1, wherein the lower most surface is the lower erosional sequence boundary (BLES).

15. The lower erosional sequence boundary of claim 14, wherein TLES is the top of the lower erosional sequence boundary.

16. The stratigraphic boundary surfaces of claim 1, wherein the middle surface is the middle erosional sequence boundary (BMES).

17. The structural aspect caused by differential compaction of claim 1, wherein if noticeable arching at the middle erosional sequence boundary (BMES), then indicative of an overlying hydrocarbon productive interval.

18. The structural aspect caused by sagging of claim 1, wherein the noticeable sag in the underlying lower erosional sequence boundary BLES is indicative of an overlying hydrocarbon productive interval.

19. The high amplitude events of claim 1, wherein is associated with a hydrocarbon productive interval.

20. The analogous field data of claim 1, wherein the data is comprised of electric logs, log cross sections and core data.
